(19) United States
(12) Patent Application Publication
(10) Pub. No.: US 2018/0291716 A1
(43) Pub. Date: Oct. 11, 2018

(54) Double Motor Non-beam Pumping Unit with a Reducer Built in the Roller

(71) Applicant: Zhishen Su, Daqing (CN)

(72) Inventor: Zhishen Su, Daqing (CN)

(21) Appl. No.: 15/657,234

(22) Filed: Jul. 24, 2017

(30) Foreign Application Priority Data
Apr. 10, 2017 (CN) 201720363741.5

(51) Int. Cl. E21B 43/12; F16H 21/30; F04B 47/02; B66D 1/12; B66D 1/20; B66D 1/22

(52) U.S. Cl. CPC E21B 43/126; F16H 21/30; B66D 1/22; B66D 1/12; B66D 1/20; F04B 47/02

(57) ABSTRACT

The utility model relating to a double motor non-beam pumping unit with a reducer built in the roller. The double motor non-beam pumping unit with a reducer built in the roller comprises a base, a tower body and a drive mechanism. The upper end of the tower body is provided with a platform and the drive mechanism is mounted on the platform. The drive mechanism comprises a motor, a reduction mechanism, a roller and a belt. According to the utility model, the reduction mechanism is built in the roller, so that the damage to the reduction mechanism caused by the natural environment such as wind, rain and sun can be avoided, thus extending the service life and maintenance cycle of the reduction mechanism and improving the stability of operation of the device.

### BACKGROUND OF THE INVENTION

### 1. Field of the Invention

The utility model belongs to the field of the non-beam pumping unit, specifically relating to a double motor non-beam pumping unit with a reducer built in the roller.

### 2. Description of the Related Art

In the petroleum exploitation, the pumping unit is one of the most commonly used oil extraction equipment and most of the pumping units used in the prior art are beam pumping units. There are problems like low mechanical transmission efficiency, high power consumption, difficulty in maintenance and high fault rate in beam pumping units due to their physical structures. To solve these problems, researchers have developed a non-beam pumping unit.

The existing non-beam pumping unit typically comprises a base, a tower body mounted on the base and a drive mechanism mounted on a platform at the top of the tower body. The drive mechanism comprises a motor, a roller, a belt and a counterweight and two ends of the belt are connected with a beam hanger and the counterweight of the pumping unit respectively. The belt is wrapped around the roller from the upper side of the roller. The motor drives the roller to rotate through the chain so that the beam hanger at both ends of the belt and the counterweight are moved up and down through driving by the belt, thus achieving the oil pumping of the pumping unit. However, the pumping unit driven by the motor and the belt drive mechanism is less stable in operation and has frequent maintenance and high maintenance costs.

### SUMMARY OF THE INVENTION

The utility model provides a double motor non-beam pumping unit with a reducer built in the roller to solve the problems proposed in the above-mentioned background art.

The utility model solves the technical problems by adopting the following technical solutions: the utility model provides a double motor non-beam pumping unit with a reducer built in the roller, comprising a base, a tower body and a drive mechanism, wherein the base is fixedly mounted on the ground; the lower end of the tower body is hinged on the base, and the upper end of the tower body is provided with a platform and the drive mechanism is mounted on the platform; the drive mechanism comprises a motor, a reduction mechanism, a roller and a belt, wherein the reduction mechanism is a planetary gear reduction mechanism that is located in the roller, and the high speed input shaft of the planetary gear reduction mechanism is located in the center of the roller and the low speed output shaft of the planetary gear reduction mechanism is the roller itself; the output shaft of the motor is connected with the high speed input shaft with a serpentine shaft coupling and both ends of the roller are provided with a dust-proof sealing cover, the motor contains two, and the motors are connected at both ends of the high speed input shaft by the serpentine shaft coupling.

The motor is a permanent magnet motor. The side of the tower body is provided with an angle incidence indicator.

The utility model has the following beneficial effects: according to the utility model, the reduction mechanism is built in the roller and the roller and the reducer are integrated together. The roller transfers the power and adjusts the speed, to simplify the device structure. Meanwhile, compared with the prior art, the above-mentioned structure has two advantages: on the one hand, the reduction mechanism is accommodated in the enclosed space in the roller, so that the damage to the reduction mechanism caused by the natural environment such as wind, rain and sun can be avoided, thus extending the service life and maintenance cycle of the reduction mechanism and improving the stability of operation of the device. On the other hand, compared with the belt drive reduction mechanism in the prior art, the planetary gear reduction mechanism has the characteristics of more stable operation, higher movement accuracy and greater torque. Therefore, the utility model has obvious advantages compared with the prior art. In addition, in the technical solutions described in the utility model, the output shaft of the motor and the high speed input shaft are connected by a serpentine shaft coupling. Unlike the common flange coupling on the non-beam pumping unit, the serpentine shaft coupling has many advantages of good vibration damping performance, long service life, large fluctuating load bearing range, safe starting, high transmission efficiency, reliable operation, low noise, good lubrication, simple structure, easy assembly and disassembly, less parts, small size, light weight and allowing a large installation deviation, especially suitable for complex operating conditions of the non-beam pumping unit.

At the same time, the utility model adopts the double motor structure, which can further improve the running stability of the pumping unit and improve the driving torque of the equipment.

### BRIEF DESCRIPTION OF THE DRAWINGS

FIG. 1 is an overall structure diagram of the utility model;

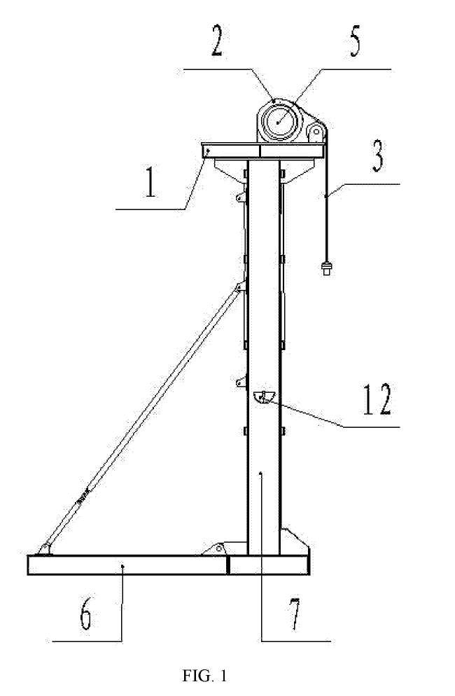

FIG. 2 is a front view of the drive mechanism in FIG. 1;

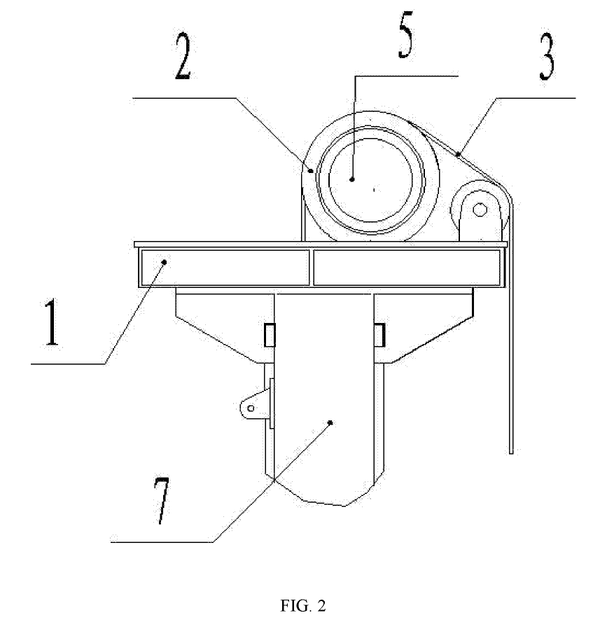

FIG. 3 is a top view of the drive mechanism;

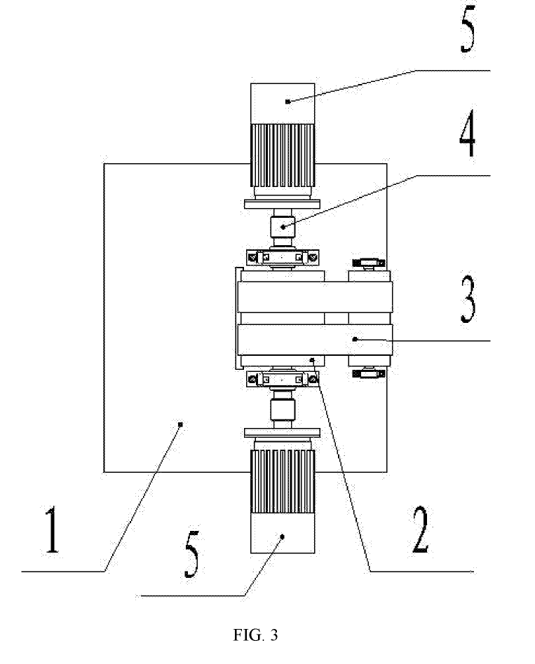

FIG. 4 is a schematic diagram of one embodiment of the planetary gear reduction mechanism.

In figures: 1—platform, 2—roller, 3—belt, 4—serpentine shaft coupling, 5—motor, 6—base, 7—tower body, 8—planetary gear, 9—gear carrier, 10—sun gear, 11—high speed input shaft, 12—angle incidence indicator.

### DETAILED DESCRIPTION OF THE PREFERRED EMBODIMENTS

The utility model is further described as follows with reference to the drawings: According to the embodiment, the double motor non-beam pumping unit with a reducer built in the roller comprises a base 6, a tower body 7 and a drive mechanism, wherein the base 6 is fixedly mounted on the ground; the lower end of the tower body 7 is hinged on the base 6, and the upper end of the tower body 7 is provided with a platform 1 and the drive mechanism is mounted on the platform 1; the drive mechanism comprises a motor 5, a reduction mechanism, a roller 2 and a belt 3. The above structure is a conventional structure in the prior art and will not be repeated here.

The reduction mechanism is a planetary gear reduction mechanism that is located in the roller 2, and the high speed input shaft of the planetary gear reduction mechanism is located in the center of the roller 2 and the low speed output shaft of the planetary gear reduction mechanism is the roller 2 itself. The reduction mechanism is built in the roller 2 and the roller 2 and the reducer are integrated together. The roller 2 transfers the power and adjusts the speed, to simplify the device structure.

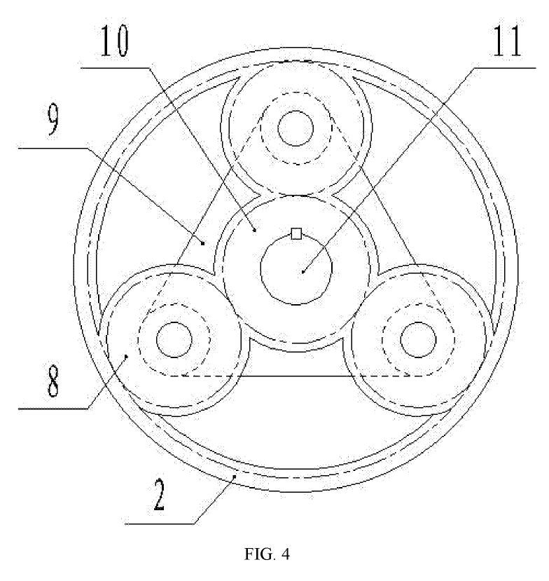

The planetary gear reduction mechanism is a reduction mechanism commonly used in the mechanical field and only one of the common structures as an embodiment is briefly described here. As shown in FIG. 4, the planetary gear reduction mechanism comprises a sun gear 10 and a planetary gear 8, wherein the sun gear 10 is mounted on the high speed input shaft 11 and the planetary gear 8 is fixedly mounted on the gear carrier 9; the gear carrier 9 is fixed and an inner gear ring is provided on the inner side of the roller 2.

According to the utility model, the reduction mechanism is built in the roller 2 and there are two advantages: on the one hand, the reduction mechanism is accommodated in the enclosed space in the roller 2, so that the damage to the reduction mechanism caused by the natural environment such as wind, rain and sun can be avoided, thus extending the service life and maintenance cycle of the reduction mechanism and improving the stability of operation of the device. On the other hand, compared with the belt drive reduction mechanism in the prior art, the planetary gear reduction mechanism has the characteristics of more stable operation, higher movement accuracy and greater torque. Therefore, the utility model has obvious advantages compared with the prior art.

The output shaft of the motor 5 is connected with the high speed input shaft with a serpentine shaft coupling 4 and both ends of the roller 2 are provided with a dust-proof sealing cover. Unlike the common flange coupling on the non-beam pumping unit, the serpentine shaft coupling 4 has many advantages of good vibration damping performance, long service life, large fluctuating load bearing range, safe starting, high transmission efficiency, reliable operation, low noise, good lubrication, simple structure, easy assembly and disassembly, less parts, small size, light weight and allowing a large installation deviation, especially suitable for complex operating conditions of the non-beam pumping unit.

The spring piece on the serpentine shaft coupling 4 is made of high quality spring steel and is specially heat treated and specially machined and has good mechanical properties. The tooth surface where two half-couplings are contacted with the spring piece is curved. When the transmission torque increases, the spring piece will deform along the tooth surface, so that the force generated due to two half-couplings acting on the spring piece gets close to the action point. The contact point between the spring piece and the tooth surface (i.e., the change in moment) changes with the transmission torque and its transmission characteristics are variable stiffness, so that it can bear greater load variation compared with the general elastic coupling. The buffer effect generated when the transmission force causes the spring piece to deform along the toothed arc, especially when the machine is started or there is the strong impact load, to a certain extent, can ensure the safety of the supporting parts. The transmission efficiency of the serpentine shaft coupling 4 is determined to be 99.47% and the short time overload capacity is twice the rated torque, so that it can operate safely and reliably. The serpentine shaft coupling 4 has characteristics of less parts, small size, light weight and easy assembly and disassembly and maintenance compared with the general coupling. The spring piece is in point contact with the tooth surface, so that the coupling can get greater flexibility. In case of radial, angular and axial deviations, it can be installed and operate normally.

The motor contains two, and the motors are connected at both ends of the high speed input shaft by the serpentine shaft coupling. The utility model adopts the double motor structure, which can further improve the running stability of the pumping unit and improve the driving torque of the equipment.

The motor 5 is a permanent magnet motor.

The side of the tower body 7 is provided with an angle incidence indicator 12 that can be used to indicate the angle of inclination of the tower body 7 to facilitate rapid adjustment of the position of the tower body 7.

1. A double motor non-beam pumping unit with a reducer built in the roller, comprising a base (6), a tower body (7) and a drive mechanism, wherein the base (6) is fixedly mounted on the ground; the lower end of the tower body (7) is hinged on the base (6), and the upper end of the tower body (7) is provided with a platform (1) and the drive mechanism is mounted on the platform (1); the drive mechanism comprises a motor (5), a reduction mechanism, a roller (2) and a belt (3), wherein the reduction mechanism is a planetary gear reduction mechanism that is located in the roller (2), and a high speed input shaft (11) of the planetary gear reduction mechanism is located in the center of the roller (2) and the low speed output shaft of the planetary gear reduction mechanism is the roller (2) itself; the output shaft of the motor (5) is connected with the high speed input shaft with a serpentine shaft coupling (4) and both ends of the roller (2) are provided with a dust-proof sealing cover, the motor (5) contains two, and the motors (5) are connected at both ends of the high speed input shaft (11) by the serpentine shaft coupling (4).

2. The double motor non-beam pumping unit with a reducer built in the roller according to claim 1, wherein the motor (5) is a permanent magnet motor.

3. The double motor non-beam pumping unit with a reducer built in the roller according to claim 1, wherein the side of the tower body (7) is provided with an angle incidence indicator (12).
